(19) United States
(12) Patent Application Publication
(10) Pub. No.: US 2007/0066782 A1
(43) Pub. Date: Mar. 22, 2007

(54) Film-forming composition, insulating film and electronic device using the same

(75) Inventor: Hidetoshi Hiraoka, Shizuoka (JP)

Correspondence Address: SUGHRUE-265550, 2100 PENNSYLVANIA AVE. NW, WASHINGTON, DC, 20037-3213, US

(73) Assignee: FUJI PHOTO FILM CO., LTD.

(21) Appl. No.: 11/520,614

(22) Filed: Sep. 14, 2006

(30) Foreign Application Priority Data
Sep. 20, 2005 (JP) P2005-272073

(51) Int. Cl. C08F 136/20

(52) U.S. Cl. 526/336

(57) ABSTRACT

A film forming composition comprising: (A) a compound having at least two radical reactive functional groups; and (B) at least one of a radical crosslinking agent having a structure represented by formula (I) as defined in the specification and a radical crosslinking agent having a structure represented by formula (II) as defined in the specification, an insulating film obtained by using the composition and an electronic device having the insulating film.

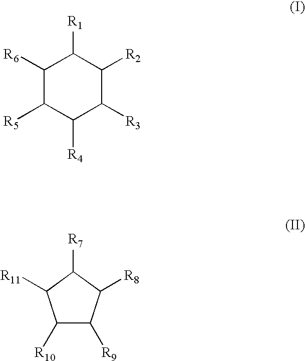

### BACKGROUND OF THE INVENTION

1. Field of the Invention

The present invention relates to a film forming composition. More specifically, the invention pertains to a composition for forming an insulating film to be used for electronic devices or the like and superior in film properties such as dielectric constant and mechanical strength, an insulating film available by using the composition, and an electronic device having the insulating film.

2. Description of the Related Art

In recent years, power consumption and delay time have increased because the progress of high integration, multifunction and high performance in the field of electronic materials has led to an increase in circuit resistance and condenser capacity between interconnects. Particularly, an increase of delay time becomes a large factor for the reduction of signal speed of devices and generation of crosstalk so that reduction of parasitic resistance and parasitic capacitance is required in order to reduce this delay time and accelerate the speed of devices. As one concrete measure for reducing this parasitic capacitance, an attempt has been made to cover the periphery of interconnects with a low-dielectric-constant interlayer insulating film. In addition, the interlayer insulating film is expected to have heat resistance high enough to withstand the thin film formation step at the time of producing a mount board and post steps such as chip connection and pin insertion and also chemical resistance high enough to withstand a wet process. Moreover, Al interconnects have recently been replaced by low resistance Cu interconnects and it is therefore common practice to carry out planarization by CMP (chemical mechanical polishing). The interlayer insulating film is therefore required to have mechanical resistance high enough to withstand this process.

Although polybenzoxazole and polyimide are widely known as materials for insulating films having high heat resistance, insulating films obtained from them are not satisfactory from the viewpoints of low dielectric constant, low water absorption, durability and hydrolysis resistance because they contain a nitrogen atom having high polarity.

Since many organic polymers usually do not have sufficient solubility in an organic solvent, it has become an important issue to prevent their precipitation in a coating solution or their appearance as foreign substances in insulating films. When the polymers adopt a folded structure for their main chain in order to improve their solubility, however, lowering in glass transition point and also lowering in heat resistance occur. It is therefore not easy to obtain polymers capable of satisfying all of these properties.

For example, low dielectric constant materials obtained by polymerizing a heat resistant hydrocarbon structure having an acetylene functional group are known (JP-A-2000-319400, JP-A-2001-55509 and JP-A-2003-174024). They however need a metal catalyst for their polymerization and removal of them reduces the production yield. In addition to this problem, a remaining metal deteriorates dielectric properties.

### SUMMARY OF THE INVENTION

The present invention relates to a film forming composition capable of overcoming the above-described problems, more specifically, a composition for forming an insulating film to be used for electronic devices which film is superior in film properties such as dielectric constant and mechanical strength and at the same time excellent in heat resistance; an insulating film available by using the composition; and an electronic device having the insulating film. (An “insulating film” is also referred to as a “dielectric film” or a “dielectric insulating film”, and these terms are not substantially distinguished.)

The present inventors have found that the above-described problems can be overcome by the below-described constitution.

(1) A film forming composition comprising:

(A) a compound having at least two radical reactive functional groups; and

(B) at least one of a radical crosslinking agent having a structure represented by formula (I) and a radical crosslinking agent having a structure represented by formula (II):

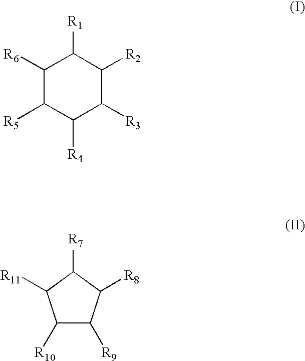

wherein R₁ to R₁₁ each independently represents a hydrogen atom or a hydrocarbon group; and

at least any two of R₁ to R₆ or at least any two of R₇ to R₁₁ may be coupled to form a ring, and

wherein a plurality of the radical crosslinking agents having a structure represented by formula (I) and a plurality of the radical crosslinking agents having a structure represented by formula (II) may be coupled to form a multimer.

(2) A film forming composition comprising a composition obtained by polymerizing a film forming composition as described in (1) above by heating.

(3) The film forming composition as described in (1) or (2) above,

wherein the radical crosslinking agent (B) has at least two alkenyl or alkynyl groups.

(4) An insulating film obtained by utilizing a film forming composition as described in any of (1) to (3) above.

(5) An electronic device comprising an insulating film as described in (4) above.

### DETAILED DESCRIPTION OF THE INVENTION

The present invention will hereinafter be described more specifically.

The film forming composition of the present invention contains (A) a compound having at least two radical reactive functional groups and (B) a radical crosslinking agent(s) having a structure represented by the below-described formula (I) and/or formula (II), or a polymer obtained by thermal polymerization of them. 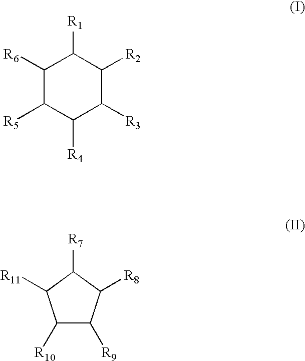
<(A) Compound having at Least Two Radical Reactive Functional Groups>

As the compound contained in the film forming composition of the present invention and having at least two radical functional groups, compounds composed mainly of a hydrocarbon skeleton are used suitably.

As the radical functional group, a functional group having an unsaturated bond is preferred. Examples of such a group include vinyl, ethynyl, allyl, 2-propenyl, isopropenyl, 2-propinyl, 3-butadienyl, 1,3-butadienyl, and 2-penten-4-yl group.

Specific examples of the “compound having at least two radical functional groups” as described in the invention will next be described, but the present invention is not limited to or by them.

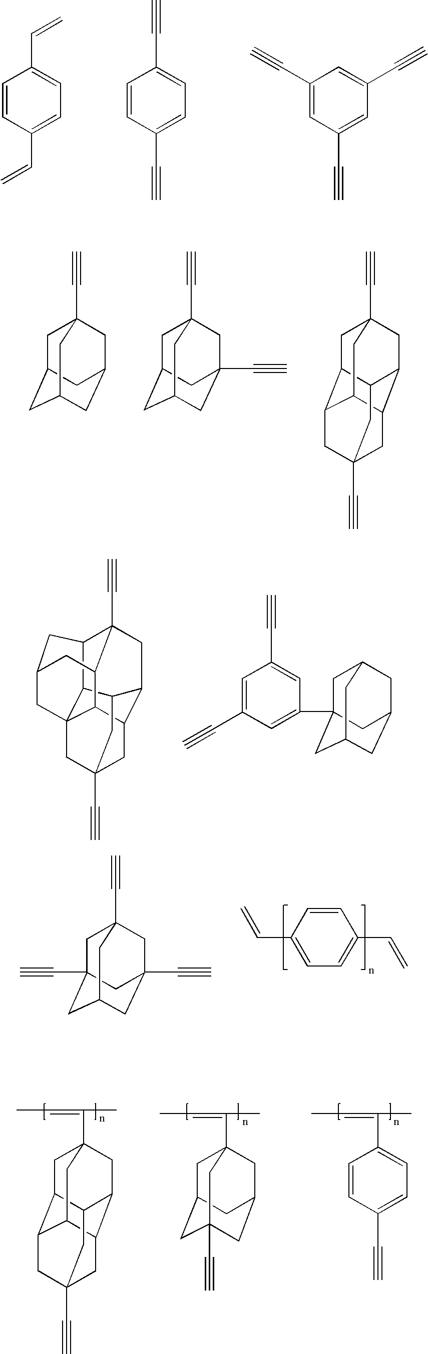

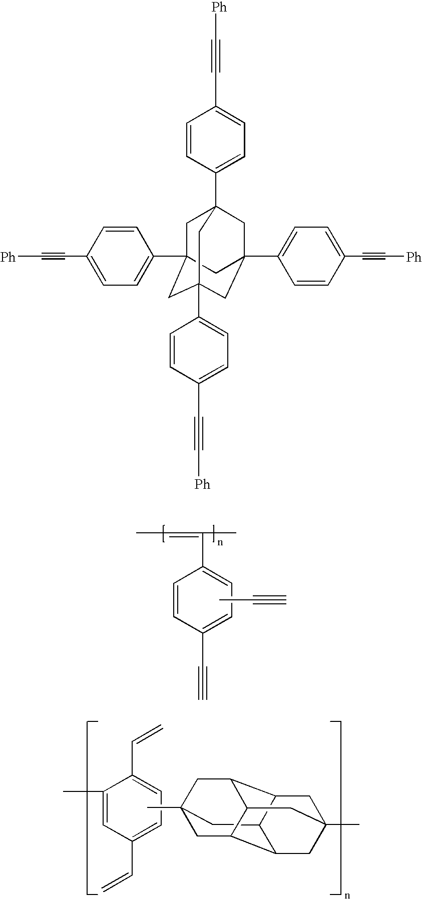

The compound having at least two radical reactive functional groups can be synthesized in a conventional manner. Commercially available products can also be used as the compound.

The compound having at least two radical reactive functional groups has preferably a molecular weight of from 500 to 500000, more preferably from 1000 to 100000.

The solid concentration (mass %) of the compound having at least two radical reactive functional groups in the film forming composition is preferably from 25% to 99%, more preferably from 60% to 95%. (In this specification, mass ratio is equal to weight ratio.)

<(B) Radical Crosslinking Agent having a Structure Represented by the Formula (I) and/or (II)>

The radical crosslinking agent represented by the below-described formula (I) and/or (II) will next be described.

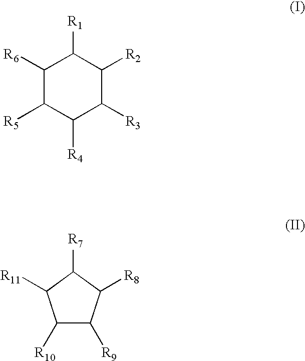

In the formulas (I) and (II),

R₁ to R₁₁ each independently represents a hydrogen atom or a hydrocarbon group,

at least any two of R₁ to R₆ or at least any two of R₇ to R₁₁ may be coupled to form a ring, and

a plurality of the crosslinking agents having a structure represented by the formula (I) and/or a plurality of the crosslinking agents having a structure represented by the formula (II) may be coupled to form a multimer. That is, the multimer may consist of the crosslinking agent having a structure represented by the formula (I) only or the crosslinking agent having a structure represented by the formula (II) only, or may consist of the mixture of the crosslinking agent having a structure represented by the formula (I) and the crosslinking agent having a structure represented by the formula (II).

The hydrocarbon group represented by R₁ to R₁₁ may be any one of linear, branched and cyclic ones, for example, methyl, ethyl, propyl, butyl, isopropyl, isobutyl, s-butyl, t-butyl, cyclobutyl, cyclopentyl, cyclohexyl, bicyclohexyl, tricyclohexyl, vinyl, ethynyl, allyl, 2-propenyl, isopropenyl, 3-propinyl, 3-butadienyl, 1,3-butadienyl and 2-penten-4-yl. It may have, as a substituent, similar structures to those represented by the formulas (I) and (II) and may form a multimer structure. In other words, a plurality of the crosslinking agents having structures represented by the formulas (I) and (II) may be coupled to form a multimer.

At least any two of R₁ to R₆ or at least any two of R₇ to R₁₁ may be coupled to form a cyclic structure. Examples of the cyclic structure which can be formed by them include cyclopropane, cyclobutane, cyclopentane, cyclohexane, cycloheptane, cyclooctane, bicyclopentane, bicyclohexane, perhydroanthracene, pyrene, and cyclohexanespirocyclopentane.

The radical crosslinking agent (B) preferably has at least two alkenyl or alkynyl groups. Examples of the alkenyl or alkynyl group include vinyl, ethynyl, allyl, 2-propenyl, isopropenyl, 2-propynyl, 3-butadienyl, 1,3-butadienyl, and 2-penten-4-yl.

Preferred examples of the radical crosslinking agent (B) include:

1,2,4-trivinylcyclohexane,

1,2,4,5-tetravinylcyclohexane,

1,2,4-triethynylcyclohexane,

1-methyl-2,4,5-trivinylcyclohexane,

1-ethyl-2,4,5-trivinylcyclohexane,

1-methyl-3,4,6-trivinylcyclohexane,

1-methyl-2,4,5-triethynylcyclohexane,

1,4-divinylcyclohexane,

1,3-divinylcyclohexane,

1,2-divinylcyclohexane,

1,4-divinylcyclopentane,

1,4-diethynylcyclohexane,

1,4-divinylcyclopentane,

1,2,4-trivinylcyclopentane,

1,2,4-triethynylcyclopentane,

3,7-divinyltricyclo[3.3.1.1^{3,7}]decane

3,7-diethynyltricyclo[3.3.1.1^{3,7}]decane

1,3,7-trivinyltricyclo[3.3.1.1^{3,7}]decane

1,3,7-triethynyltricyclo[3.3.1.1^{3,7}]decane,

3,5-divinyltricyclo[2.2.1.0^{2.6}]heptane

3,5-diethynyltricyclo[2.2.1.0^{2.6}]heptane,

3,4,5-trivinyltricyclo[2.2.1.0^{2.6}]heptane,

3,4,5-triethynyltricyclo[2.2.1.0^{2.6}]heptane,

4,9-divinyltricyclo[5.2.1^{2.6}]decane

8,9-divinyltricyclo[5.2.1^{2.6}]decane,

3,5-divinyltricyclo[5.2.1^{2.6}]decane,

4,9-diethynyltricyclo[5.2.1^{2.6}]decane,

4,9,8-trivinyltricyclo[5.2.1^{2.6}]decane,

2,3-divinylbicyclo[2.2.1]heptane,

2,3,6-trivinylcyclo[2.2.1]heptane,

2,3-diethynylbicyclo[2.2.1]heptane, and

2,3,6-triethynylbicyclo[2.2.1]heptane.

There exists a suitable range of the amount of the radical crosslinking agent (B) to be added, depending on the solid concentration of the film forming composition. In general, the solid concentration (mass %) of the film forming composition is preferably from 0.1% to 100%, more preferably from 1% to 100%, especially preferably from 10% to 100%.

The radical crosslinking agent (B) can be synthesized in the conventional manner. A commercially available one can also be used.

The radical crosslinking agent represented by the formula (I) or (II) has a molecular weight preferably from 90 to 5000, more preferably from 90 to 1000.

The film forming composition of the invention can be used as a coating solution containing a solvent.

Although no particular limitation is imposed on the solvent preferred in the invention, examples of it include alcohol solvents such as methanol, ethanol, isopropanol, 1-butanol, 2-ethoxymethanol and 3-methoxypropanol; ketone solvents such as acetone, acetylacetone, methyl ethyl ketone, methyl isobutyl ketone, 2-pentanone, 3-pentanone, 2-heptanone, 3-heptanone, and cyclohexanone; ester solvents such as ethyl acetate, propyl acetate, butyl acetate, isobutyl acetate, pentyl acetate, ethyl propionate, propyl propionate, butyl propionate, isobutyl propionate, propylene glycol monomethyl ether acetate, methyl lactate, ethyl lactate and γ-butyrolactone; ether solvents such as diisopropyl ether, dibutyl ether, ethyl propyl ether, anisole, phenetole, and veratrole; aromatic hydrocarbon solvents such as mesitylene, ethylbenzene, diethylbenzene, propylbenzene and 1,2-dichlorobenzene; and amide solvents such as N-methylpyrrolidinone and dimethylacetamide. These solvents may be used singly or in combination.

Of these, acetone, propanol, cyclohexanone, propylene glycol monomethyl ether acetate, methyl lactate, ethyl lactate, γ-butyrolactone, anisole, mesitylene and 1,2-dichlorobenzene are more preferred.

The solid concentration of the film forming composition of the invention is preferably from 0.1 to 100 mass %, more preferably from 1 to 100 mass %, especially preferably from 10 to 100 mass %.

The radical reactivity of the film forming composition to be used in the invention can be improved by the addition thereto a thermal initiator in advance. Although no particular limitation is imposed on the thermal initiator, examples of it include benzoyl peroxide, dicumyl peroxide, t-butyl peroxide, lauroyl peroxide, methyl ethyl ketone peroxide, and azobisisobutyronitrile.

There exists a suitable range of the amount of the thermal initiator to be added, depending on the solid concentration of the coating solution. In general, the amount (mass %) in the coating solution is preferably from 0.01% to 20%, more preferably from 0.1% to 10%, especially preferably from 0.5% to 5%.

By the addition, in advance, of a foaming agent to the film forming composition to be used in the invention, a porous film can be formed. Although no particular limitation is imposed on the foaming agent to be added to form a porous film, a thermally decomposable low molecular compound, thermally decomposable polymer or the like can, for example, be used.

There exists a suitable range of the amount of the foaming agent to be added, depending on the solid concentration of the coating solution. In general, the amount (mass %) of it in the coating solution is preferably from 0.01% to 20%, more preferably from 0.1% to 10%, especially preferably from 0.5% to 5%.

Moreover, additives such as nonionic surfactant, nonionic fluorosurfactant and silane coupling agent may be added to the film forming composition of the invention insofar as they do not impair the various properties (heat resistance, dielectric constant, mechanical strength, coating properties, adhesion and the like) of an insulating film.

Examples of the nonionic surfactant include octyl polyethylene oxide, decyl polyethylene oxide, dodecyl polyethylene oxide, octyl polypropylene oxide, decyl polypropylene oxide and dodecyl polypropylene oxide. Examples of the nonionic fluorosurfactant include perfluorooctyl polyethylene oxide, perfluorodecyl polyethylene oxide and perfluorododecyl polyethylene oxide. Examples of the silane coupling agent include vinyl trimethoxysilane, vinyltriethoxysilane, vinyltriacetoxysilane, allyltrimethoxysilane, allyltriethoxysilane, divinyldiethoxysilane and trivinylethoxysilane, and hydrolysates and dehydrated condensates thereof.

There exists a suitable range of the amount of the additive to be added, depending on the using purpose of the additive or solid concentration of the coating solution. In general, the amount (mass %) in the coating solution is preferably from 0.001% to 10%, more preferably from 0.01% to 5%, especially preferably from 0.05% to 2%.

The film forming composition of the invention may contain a polymer obtained by thermal polymerization of the compound (A) having at least two radical reactive functional groups and the radical crosslinking agent (B). The polymer is available by the thermal polymerization at preferably from 0 to 300° C., more preferably from 40 to 250° C., especially preferably from 80 to 250° C., though depending on what is incorporated in the mixture. Heating time is preferably from 1 minute to 10 hours, more preferably from 10 minutes to 2 hours, especially preferably from 30 minutes to 1 hour. Aging under heating may be performed in several steps.

The composition obtained by polymerization can also be used as a coating solution after adding, to the composition, an organic solvent, thermal initiator, nonionic surfactant, nonionic fluorosurfactant, silane coupling agent, or the like.

When the polymer obtained by thermal polymerization is used as the film forming composition, the amount (mass %) of it in a coating solution is preferably from 10% to 90%, more preferably from 15% to 50%.

The film forming composition of the invention may contain the compound (A) having at least two radical reactive functional groups and the radical crosslinking agent (B) separately or may contain a polymer obtained by thermal polymerization of them, or may contain both of them.

The film forming composition of the invention may contain, as each component, one or more kinds.

The film available by using the film forming composition of the invention is suited as an insulating film in electronic parts such as semiconductor device and multichip module multilayer wiring board. It can also be used as, in addition to an interlayer insulating film for semiconductor, surface protecting film and a buffer coat film, a passivation film in LSI, α-ray shielding film, cover lay film of a flexographic plate, overcoat film, cover coat of a flexible copper-lined plate, solder resist film, or liquid-crystal alignment film. In addition, it can be used for various purposes such as a filter film for water treatment, soil conditioner carrier, optical environmental catalyst carrier, and building material.

Films such as insulating film can be formed by applying the film forming composition of the invention to a substrate by a desirable method selected from spin coating, roller coating, dip coating, scanning and the like, and then heating the substrate.

No particular limitation is imposed on the heating method. Any ordinary method, for example, heating using a hot plate or heating furnace, or heating by photoirradiation with a xenon lamp for RTP (rapid thermal processor) is employable herein.

Although no particular limitation is imposed on the thickness of the coating film, it is preferably from 0.001 to 100 μm, more preferably from 0.01 to 10 μm, especially preferably from 0.1 to 1 μm.

It is preferred that the components constituting the film forming composition of the invention are crosslinked each other by heating after application to form an insulating film excellent in mechanical strength and heat resistance. With regard to the optimum conditions of this heat treatment, the heating temperature is preferably from 200 to 450° C., more preferably from 200 to 420° C., especially preferably from 350° C. to 400° C., while the heating time is preferably from 1 minute to 2 hours, more preferably from 10 minutes to 1.5 hours, especially preferably from 30 minutes to 1 hour. The heating treatment may be performed in several steps.

### EXAMPLE 1

The invention will next be described by Examples, but it should however be borne in mind that the scope of the invention is not limited by them.

### EXAMPLE 1

To a 500 mL flask were added 50 g of commercially available 1,2,4-trivinylcyclohexane, 0.1 g of t-butyl peroxypivalate and 200 mL of dichloroethane. The resulting mixture was stirred at an internal temperature of 55° C. for 1 hour. After cooling for 1 hour at ordinary temperature, the reaction mixture was passed through a column to obtain a polymer solution A from which insoluble matters had been removed. To another 500 mL flask were added 50 g of commercially available p-divinylbenzene, 0.1 g of t-butyl peroxypivalate (“Lupezole 11”, trade name; product of ARKEMA YOSHITOMI) and 200 mL of p-xylene. The resulting mixture was stirred for 1 hour at an internal temperature of 55° C. After cooling for 1 hour at ordinary temperature, the reaction mixture was passed through a column to obtain a polymer solution B from which insoluble matters had bee removed. The polymer solutions A and B thus obtained were mixed and stirred at ordinary temperature for 50 minutes. The resulting mixed solution was spin-coated on a silicon wafer, heated on a hot plate under a nitrogen stream for 2 minutes at 110° C. and for 3 minutes at 200° C., and heated further for 1 hour at 350° C. in a clean oven. The dielectric constant of the insulating film thus obtained having a thickness of 0.5 μm was calculated from the capacitance value at 1 MHz by using a mercury probe (product of Four Dimensions) and “HP 4285A LCR meter” (trade name; product of Yokogawa Hewlett Packard), and it was 2.55. As a result of measurement by using “Nano Indenter SA2” (trade name; product of MTS Systems), the Young's modulus of the film was 7.5 GPa. As a result of measurement by using “TGA Q500” (trade name; product of TA Instruments), temperature causing a 10% weight loss was 432° C.

### EXAMPLE 2

To a 500 mL flask were added 50 g of commercially available p-divinylbenzene, 0.1 g of t-butyl peroxypivalate (“Lupezole 11”, trade name; product of ARKEMA YOSHITOMI), 50 g of commercially available 1,2,4-trivinylcyclohexane and 200 mL of p-xylene. The resulting mixture was stirred for 1 hour at an internal temperature of 55° C. After cooling for 1 hour at ordinary temperature, the reaction mixture was passed through a column to obtain a polymer solution from which insoluble matters had been removed. The polymer solution thus obtained was spin-coated on a silicon wafer, heated on a hot plate under a nitrogen stream for 2 minutes at 110° C. and for 3 minutes at 200° C., and heated further for 1 hour at 350° C. in a clean oven. The dielectric constant of the insulating film thus obtained having a thickness of 0.5 μm was calculated from the capacitance value at 1 MHz by using a mercury probe (product of Four Dimensions) and “HP 4285A LCR meter” (trade name; product of Yokogawa Hewlett Packard), and it was 2.49. As a result of measurement by using “Nano Indenter SA2” (trade name; product of MTS Systems), the Young's modulus of the film was 7.8 GPa. As a result of measurement by using “TGA Q500” (trade name; product of TA Instruments), temperature causing a 10% weight loss was 440° C.

### EXAMPLE 3

To a 500 mL flask were added 50 g of commercially available 1,2,4-trivinylcyclohexane, 0.1 g of t-butyl peroxypivalate (“Lupezole 11”, trade name; product of ARKEMA YOSHITOMI), and 200 mL of p-xylene. The resulting mixture was stirred for 1 hour at an internal temperature of 55° C. After cooling for 1 hour at ordinary temperature, the reaction mixture was passed through a column to obtain a polymer solution from which insoluble matters had been removed. The polymer solution thus obtained was spin-coated on a silicon wafer, heated on a hot plate under a nitrogen stream for 2 minutes at 110° C. and for 3 minutes at 200° C., and heated further for 1 hour at 350° C. in a clean oven. The dielectric constant of the insulating film thus obtained having a thickness of 0.5 μm was calculated from the capacitance value at 1 MHz by using a mercury probe (product of Four Dimensions) and “HP 4285A LCR meter” (trade name; product of Yokogawa Hewlett Packard), and it was 2.41. As a result of measurement by using “Nano Indenter SA2” (trade name; product of MTS Systems), the Young's modulus of the film was 7.1 GPa. As a result of measurement by using “TGA Q500” (trade name; product of TA Instruments), temperature causing a 10% weight loss was 421° C.

### COMPARATIVE EXAMPLE 1

To a 500 mL flask were added 50 g of commercially-available p-divinylbenzene, 0.1 g of t-butyl peroxypivalate (“Lupezole 11”, trade name; product of ARKEMA YOSHITOMI), and 200 mL of p-xylene. The resulting mixture was stirred for 1 hour at an internal temperature of 55° C. After cooling for 1 hour at ordinary temperature, the reaction mixture was passed through a column to obtain a polymer solution from which insoluble matters had been removed. To the resulting polymer solution was added 5 g of trimethylolpropane trimethacrylate and the resulting mixture was stirred at ordinary temperature for 30 minutes. The resulting mixed solution was spin-coated on a silicon wafer, heated on a hot plate under a nitrogen stream for 2 minutes at 110° C. and for 3 minutes at 200° C., and heated further for 1 hour at 350° C. in a clean oven. Owing to a severe loss in film thickness due to thermal decomposition, a film was formed by changing the amount of p-xylene to 100 mL. The dielectric constant of the insulating film thus obtained having a thickness of 0.5 μm was calculated from the capacitance value at 1 MHz by using a mercury probe (product of Four Dimensions) and “HP 4285A LCR meter” (trade name; product of Yokogawa Hewlett Packard), and it was 3.28. As a result of measurement by using “Nano Indenter SA2” (trade name; product of MTS Systems), the Young's modulus of the film was 3.7 GPa. As a result of measurement by using “TGA Q500” (trade name; product of TA Instruments), temperature causing a 10% weight loss was 377° C.

### COMPARATIVE EXAMPLE 2

To a 500 mL flask were added 50 g of commercially-available p-divinylbenzene, 0.1 g of t-butyl peroxypivalate (“Lupezole 11”, trade name; product of ARKEMA YOSHITOMI), and 200 mL of toluene. The resulting mixture was stirred for 1 hour at an internal temperature of 55° C. After cooling for 1 hour at ordinary temperature, the reaction mixture was passed through a column to obtain a polymer solution from which insoluble matters had been removed. The resulting polymer solution was spin-coated on a silicon wafer, heated on a hot plate under a nitrogen stream for 2 minutes at 110° C. and for 3 minutes at 200° C., and heated further for 1 hour at 350° C. in a clean oven. Owing to a severe loss in film thickness due to thermal decomposition, a film was formed by changing the amount of toluene to 150 mL. The dielectric constant of the insulating film thus obtained having a thickness of 0.5 μm was calculated from the capacitance value at 1 MHz by using a mercury probe (product of Four Dimensions) and “HP 4285A LCR meter” (trade name; product of Yokogawa Hewlett Packard), and it was 3.28. As a result of measurement by using “Nano Indenter SA2” (trade name; product of MTS Systems), the Young's modulus of the film was 2.9 GPa. As a result of measurement by using “TGA Q500” (trade name; product of TA Instruments), temperature causing a 10% weight loss was 365° C.

An insulating film formed using the film forming composition of the present invention is superior in film properties such as dielectric constant and mechanical strength and excellent in heat resistance so that it can be used as an interlayer insulating film in electronic devices and the like.

The entire disclosure of each and every foreign patent application from which the benefit of foreign priority has been claimed in the present application is incorporated herein by reference, as if fully set forth.

What is claimed is:

1. A film forming composition comprising:
(A) a compound having at least two radical reactive functional groups; and
(B) at least one of a radical crosslinking agent having a structure represented by formula (I) and a radical crosslinking agent having a structure represented by formula (II): 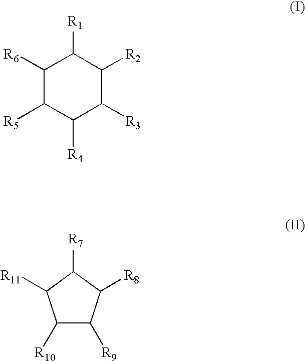
wherein R₁ to R₁₁ each independently represents a hydrogen atom or a hydrocarbon group; and
at least any two of R₁ to R₆ or at least any two of R₇ to R₁₁ may be coupled to form a ring, and
wherein a plurality of the radical crosslinking agents having a structure represented by formula (I) and a plurality of the radical crosslinking agents having a structure represented by formula (II) may be coupled to form a multimer.

2. A film forming composition comprising a composition obtained by polymerizing a film forming composition according to claim 1 by heating.

3. The film forming composition according to claim 1,
wherein the radical crosslinking agent (B) has at least two alkenyl or alkynyl groups.

4. An insulating film obtained by utilizing a film forming composition according to claim 1.

5. An electronic device comprising an insulating film according to claim 4.
